(19) United States
(12) Patent Application Publication
(10) Pub. No.: US 2015/0188988 A1
(43) Pub. Date: Jul. 2, 2015

(54) ELECTRONIC DEVICES, AND FILE SHARING METHODS THEREOF

(71) Applicant: HTC Corporation, Taoyuan City (TW)

(72) Inventor: Chung-Huan MEI, Taoyuan City (TW)

(73) Assignee: HTC Corporation, Taoyuan City (TW)

(21) Appl. No.: 14/141,746

(22) Filed: Dec. 27, 2013

(51) Int. Cl. H04L 29/08; G06F 3/041; G06F 3/01; H04W 4/00

(52) U.S. Cl. CPC H04L 67/10; H04W 4/008; G06F 3/0416; G06F 3/017

(57) ABSTRACT

File sharing methods for electronic devices with a display unit and a compass sensor are provided, wherein the electronic device is wirelessly connected to a nearby device. First, a file-sharing request is received from the nearby device, wherein the file-sharing request includes a first geographic data of the nearby device, angle information indicating a sliding-out angle relative to the first geographic data, and a file. A second geographic data is then obtained from the sensor unit of the electronic device. It is determined a first angle for receiving the file according to the first geographic data, the angle information and the second geographic data and the file is received from the first angle.

### BACKGROUND OF THE INVENTION

1. Field of the Invention

The disclosure relates generally to electronic devices and related file sharing methods, and more particularly to electronic devices and related file sharing methods capable of performing file sharing among devices which are wirelessly connected and located within a short range.

2. Description of the Related Art

Recently, electronic devices, such as mobile phones, smart phones or PDAs (Personal Digital Assistants), have become more and more technically advanced and multifunctional. Because of the conveniences of these devices, the devices have become necessities of life.

For some handheld devices, such as smart phones, PDAs, tablet PCs etc., a touch screen may be provided as a main input device for users to control functions thereof. Users of the handheld devices can use their fingers to select items displayed on the touch screen to issue a command, and perform or control operations corresponding to the selected items. For example, users can click on a virtual button or graphic icon displayed on the touch screen to activate a drawing function, or can click on another button or icon displayed on the touch screen to activate a GPS navigation function.

As user requirements and behaviors change, data (e.g. multimedia files, messages or the like) sharing capability among different devices have become necessities of the handheld devices. Handheld devices allow users to share files by employing different methods such as emails, texting, multimedia message service and so on, and when data is to be shared, users may perform a number of operations to start data transmission. However, these file sharing methods are limiting, cumbersome and time consuming. Therefore, it is desired to provide a more attractive data and file sharing method for users.

### BRIEF SUMMARY OF THE INVENTION

Electronic devices and file sharing methods using the same are provided to provide file sharing among devices located within a short range.

In an embodiment of a file sharing method, applied to an electronic device which at least comprises a display unit and a sensor unit and is wirelessly connected to a nearby device, a file-sharing request is first received from the nearby device, wherein the file-sharing request includes a first geographic data of the nearby device, angle information indicating a sliding-out angle relative to the first compass data and a file. A second geographic data is then obtained from the sensor unit. It is determined a first angle for receiving the file according to the first geographic data, the angle information and the second geographic data, and the file is received from the first angle.

An embodiment of an electronic device comprises a display unit arranged for displaying a user interface, a sensor unit providing a geographic data, and a processing unit. The electronic device is wirelessly connected to a nearby device. The processing unit is arranged for receiving a file sharing request from the nearby device, wherein the file-sharing request comprises a first geographic data of the nearby device, angle information indicating a sliding-out angle relative to the first geographic data and a file; obtaining a second geographic data from the sensor unit; and determining a first angle for receiving the file according to the first geographic data, the angle information and the second geographic data.

File sharing methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a data transmission system of the invention;

FIG. 2 is a flowchart of an embodiment of a file sharing method of the invention;

FIG. 3 is a flowchart of another embodiment of a file sharing method of the invention;

FIG. 4 is a schematic diagram illustrating an embodiment of an angle calculation of the invention; and

FIG. 5 is a flowchart of another embodiment of a file sharing method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

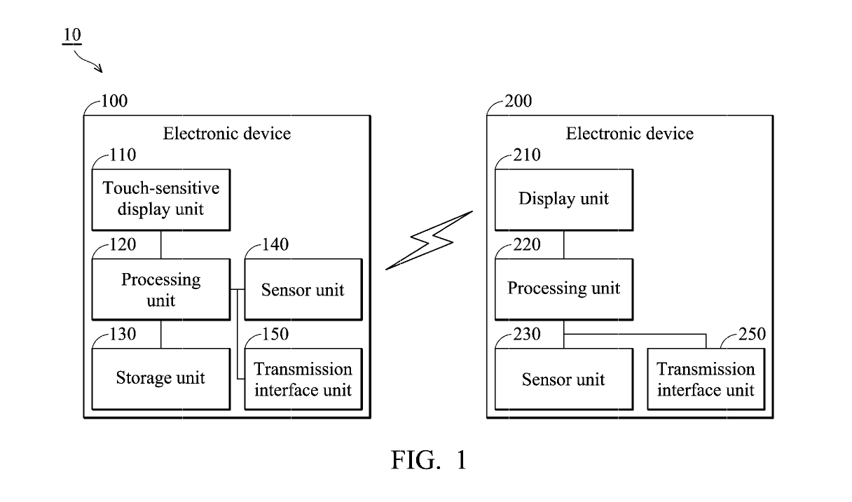

FIG. 1 is a schematic diagram illustrating an embodiment of a data transmission system of the invention. The data transmission system 10 of the invention at least comprises an electronic device 100 and an electronic device 200, wherein the electronic device 100 and the electronic device 200 are within a limited distance, and are communicated with each other through a wireless communication protocol, such as infra-red (IR), Near field communication, WiFi, Bluetooth protocol or other suitable communication protocol. The electronic device 200 may be an electronic device which is the same as the electronic device 100 or other type of electronic device, such as smart phone, PDA (Personal Digital Assistant), laptop computer or tablet computer. The electronic device 100 and the electronic device 200 may not be located at specific direction or angle relative to each other.

The electronic device 100 may at least comprise a touch-sensitive display unit 110, a processing unit 120, a storage unit 130, a sensor unit 140 and a transmission interface unit 150. It is understood that, in some embodiments, the touch-sensitive display unit 110 may be a display device integrated with a touch-sensitive device (not shown). The touch-sensitive device comprises a touch-sensitive surface comprising sensors in at least one dimension to detect contact and/or movement of at least one object (input tool), such as a pen/stylus or finger near or on the touch-sensitive surface. The touch-sensitive display unit 110 can display related data, such as texts, figures, interfaces, and/or information.

The storage unit 130 stores at least one file and a number of gesture recognition data. The gesture recognition data within the storage unit 130 may further be provided to the processing unit 120 for subsequent determination of the type of gesture input. The processing unit 120 which is coupled to the touch-sensitive display unit 110 can perform the file sharing method of the present invention, which will be discussed further in the following paragraphs.

The sensor unit 140 can measure/provide the geographic information (e.g. a tilt angle) of the electronic device 100 and provide the measured geographic data to the processing unit 120. The sensor unit 140 may include, for example but not limited to, one or more of gyro sensor, acceleration sensor, gravity sensor, compass sensor (e.g. E-compass), GPS and the like. For example, the sensor unit 140 can use the acceleration sensor or the gravity sensor to measure the tilt angle relative to the ground, or use the compass sensor to measure an azimuth angle of the electronic device 100.

The transmission interface unit 150 is configured to transmit or receive data file to be shared among the electronic devices 100 and 200. The transmission interface unit 150 may support wireless transmission of one or more protocols, such as infra-red (IR), Near Field Communication (NFC), WiFi, Bluetooth or other suitable communication protocol. Furthermore, data to be transmitted may be encoded or compressed in suitable format depending on the transmission protocol used for current transmission.

The electronic device 200 comprises at least a display unit 210, a processing unit 220 and a sensor unit 230, wherein the display unit 210 at least displays a user interface and related data and icons. Similarly, in one embodiment, the display unit 210 is the same as the touch-sensitive display unit 110. Similarly, the sensor unit 230 can measure/provide the geographic information (e.g. the tilt angle) of the electronic device 200 and provide the measured geographic data to the processing unit 220. For example, the sensor unit 230 can use the compass sensor to measure an azimuth angle of the electronic device 200 and provide it to the processing unit 220. The processing unit 220 which is coupled to the touch-sensitive display unit 210 can perform the file sharing method of the present invention, which will be discussed further in the following paragraphs. The electronic device 200 also comprises transmission interface unit 250 for receiving and transmitting data shared with the electronic device 200. Similarly, the transmission interface unit 250 may support wireless transmission of one or more protocols, such as infra-red (IR), Near Field Communication (NFC), WiFi, Bluetooth or other suitable communication protocol. Furthermore, data to be transmitted may be encoded or compressed in suitable format depending on the transmission protocol used for current transmission.

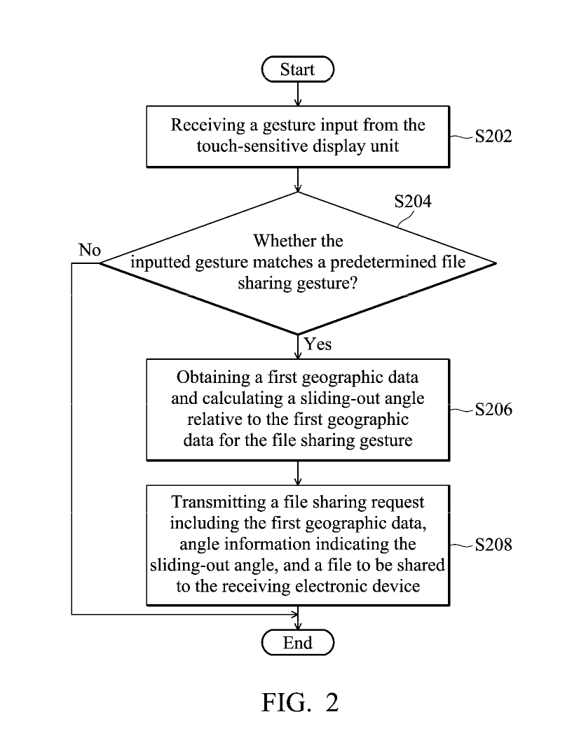

FIG. 2 is a flowchart of an embodiment of a file sharing method for transmitting a file of the invention. Please refer to FIGS. 1 and 2. The file sharing method can be applied to an electronic device, such as a portable device, e.g. a PDA, a PDA phone, a smart phone, a mobile phone, an MID, a laptop computer, a tablet computer, a car computer, a digital camera, a multi-media player, a game device, or any other type of handheld device. However, it is to be understood that the invention is not limited thereto. It is to be noted that, in this embodiment, the electronic device (e.g. the electronic device 100) comprises a touch-sensitive display unit and a sensor unit (e.g. a compass sensor) and is wirelessly connected to a nearby device (e.g. the electronic device 200). Note that the electronic device and the nearby device are within a limited distance, and are communicated with each other through a wireless communication protocol, such as infra-red (IR), Near field communication, WiFi or Bluetooth protocol or other suitable communication protocol.

First, when a user wishes to request for file sharing, the user may touch and generate a sliding-out gesture on the touch-sensitive display unit 110 and thus, in step S202, the processing unit 120 receives a gesture input from the touch-sensitive display unit 110 and determines, in step S204, whether the gesture input matches a predetermined file sharing gesture which is a gesture representing a file sharing request. In this step, the processing unit 120 may detect a touch on the touch-sensitive display unit 110 and determine whether the touch is a gesture input. When the touch is determined as the gesture input, the processing unit 120 receives the gesture inputted on the touch-sensitive display unit 110. Note that users are able to input a gesture via a movement of at least one object (input tool), such as a pen/stylus or finger near or on the touch-sensitive surface. For example, if the file sharing gesture is defined as a flicking or sliding-out gesture, which is defined as an action that presses an icon of a file selected to be transmitted and flicks/slides the icon out by their finger with a sliding-out direction toward a receiving device (e.g. toward the electronic device 200 at the right side from the left side), the determination of whether the gesture input represents a file sharing gesture can be performed by determining whether the gesture input matches the predefined sliding-out gesture. When the gesture input is determined as not matching with a file sharing gesture (No in step S204), the processing unit 120 may perform other processes that corresponds to the gesture input, such as to activate a selection item or perform an operation on the selected item, to end the operation.

When the gesture input is determined as matching with the file sharing gesture (Yes in step S204), in step S206, the processing unit 120 obtains a first geographic data, for example compass data (i.e. the azimuth angle of the electronic device 100), by using the sensor unit, for example compass sensor, and calculates a sliding-out angle relative to the first compass data for the file sharing gesture. Then, in step S208, the processing unit 120 transmits a file sharing request including the first geographic data, angle information indicating the sliding-out angle, and a file to be shared to the electronic device 200 which is served as the receiving device.

It is to be understood that, angle information of the file sharing gesture may be determined based on a set of gesture information relative to the gesture, wherein the set of gesture information is information regarding the movement detected on the touch-sensitive display unit 110, such as the starting point, the ending point and the velocity for the gesture. In some embodiments, the angle information may be obtained by using the sensor unit 140. The sensor unit 140 may comprise at least one of G-sensor, Gyroscope, GPS and e-compass or other sensors that can be used to determine direction or position of the electronic device. By the sensed data provided by the sensors (e.g. the e-compass sensor), an azimuth angle of the electronic device 100 and an sliding-out angle relative to the azimuth angle measured by the sensor for the file sharing gesture as well as the velocity, acceleration and other information related to the electronic device 100 can be obtained.

After the gesture information containing the first geographic data for the electronic device 100 and the angle information indicating the sliding-out angle relative to the first geographic data for the file sharing gesture has been obtained, in step S208, the processing unit 120 transmits a file sharing request containing the first geographic data of the electronic device 100 and the angle information, and a file to be shared to at least one electronic device 200. The file may comprise multimedia files, such as audio, video, picture files and other type of files which can be transmitted and shared to each other. For example, a header data containing the file data and responsive directional information for the file transmission can be transmitted to the electronic device 200. The electronic device 100 may utilize a vector as well as information regarding a file to be shared, a first geographic data (e.g. a compass sensor angle UP1) of the electronic device 100 and angle information indicating a sliding-out angle SOA relative to the compass sensor angle UP1 as the content of the header data that is to be transmitted to the electronic device 200 and transmit a file sharing request containing the header data and the file to be shared to the electronic device 200.

Because the gesture information corresponds to the touch-sensitive display unit, if the absolute position of the touch-sensitive display unit for the transmitting device and the receiving device are different due to they are located at different positions in different angles relative to the earth pole or some coordinate systems, other electronic devices will not recognize the actual direction that the gesture information generated on the transmitting device at the transmitting end represents based on the gesture information received from the transmitting device at the transmitting end. Thus, it may erroneously determine a wrong direction or result in an incorrect result when a determination of the transmission direction that is the direction the file being sent out is to be made based on the gesture information.

According to embodiments of the invention, through a difference between the geographic data (for example the azimuth angles) of the electronic device 100 and the electronic device 200, a transmission direction that the direction the file being sent out can be compensated and correctly obtained. For example, when user slides the file to the eastern direction, another electronic device may receive file from western direction. In this embodiment, a compass data, which is determined by using the sensed data provided by the sensors, can serve as a reference to map the aforementioned gesture information (e.g. information regarding the starting point and the ending point for the gesture and the velocity of device and the sliding-out angle) to generate an absolute directional information corresponding to the reference. The compass data and the angle information may represent information regarding the direction that the gesture is sent, so other electronic devices which are located at different directions or angles may correctly decode the gesture direction represented by the compass data and the angle information. If the receiving electronic device determines that it is not located at a position which is relative to the sending electronic device the same as or similar to the gesture direction, the receiving electronic device may ignore the file to be shared. Note that the compass data is used for compensating the angular deviation between the electronic device 100 and the electronic device 200, and thus the electronic device 200 can simulate the correct transmitted direction by using the compass data. Thereafter, the electronic device 200 may know the actual direction of the vector that corresponds to the gesture (e.g. the sliding-out direction) based on the information included in the file sharing request.

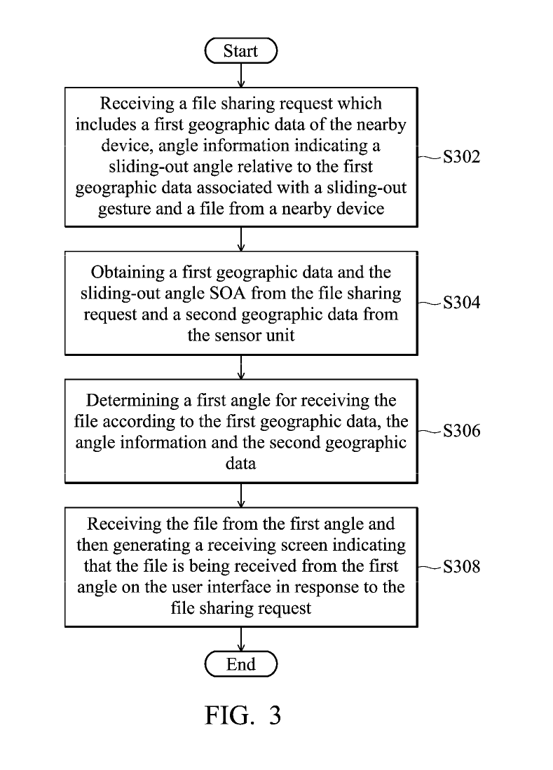

FIG. 3 is a flowchart of an embodiment of a file sharing method for receiving a file of the invention. The file sharing method can be applied to an electronic device, such as a TV, a desktop computer or the like, or a portable device, e.g. a PDA, a smart phone, a mobile phone, an MID, a laptop computer, a tablet computer, a car computer, a digital camera, a multi-media player, a game device, or any other type of handheld device. However, it is to be understood that the invention is not limited thereto. It is to be noted that, in this embodiment, the electronic device can be the electronic device 200 and the nearby device can be the electronic device 100 shown in FIG. 1, wherein the electronic device 200 comprises at least a display unit 210, a processing unit 220 and a sensor unit 230 and a transmission interface unit 250. The display unit 210 displays a user interface UI.

In step S302, the electronic device 200 receives a file sharing request from a nearby device (e.g. the electronic device 100), wherein the file sharing request includes a file to be shared, a first geographic data (in this embodiment a compass sensor angle UP1) of the electronic device 100 and angle information indicating a sliding-out angle SOA relative to the compass sensor angle UP1.

Upon receiving the file sharing request from the nearby device, the electronic device 200 may further prompt the user to confirm whether to receive the file so as to confirm the file sharing operation. When it is confirmed by the user, in step S304, the processing unit 220 obtains the first geographic data of the electronic device 100 and the sliding-out angle SOA from the file sharing request, and obtains a second geographic data (in this embodiment a compass sensor angle UP2) of the electronic device 200. And then determines, in step S306, a first angle (e.g. a sliding-in angle SIA) for receiving the file based on the compass sensor angle UP1 of the electronic device 100 and the sliding-out angle SOA within the file sharing request and the compass sensor angle UP2 of the electronic device 200. It should be noted that the compass sensor angle UP2 of the electronic device 200 can be obtained by using the compass sensor of the electronic device 200. As the electronic device 100 transmits the compass sensor angle UP1 of the electronic device 100 and the sliding-out angle SOA to the electronic device 200, the electronic device 200 can determine the direction that the gesture of the electronic device 100 is directed to based on the compass sensor angle UP1 of the electronic device 100, the sliding-out angle SOA, and the compass sensor angle UP2 of the electronic device 200.

In some embodiments, the step of determining the first angle for receiving the file according to the first geographic data, the angle information and the second geographic data can be performed by calculating a difference between the first geographic data and the second geographic data, and determining the first angle by subtracting the calculated difference from the sliding-out angle SOA included in the angle information. In some embodiments, prior to transmitting the file sharing request, the electronic device may first calculate a sum of the compass sensor angle UP1 of the electronic device 100 and the sliding-out angle SOA, and then send the calculated sum to the nearby device so that the nearby device can determine the direction that the gesture of the electronic device is directed to based on the sum and its compass sensor angle UP2.

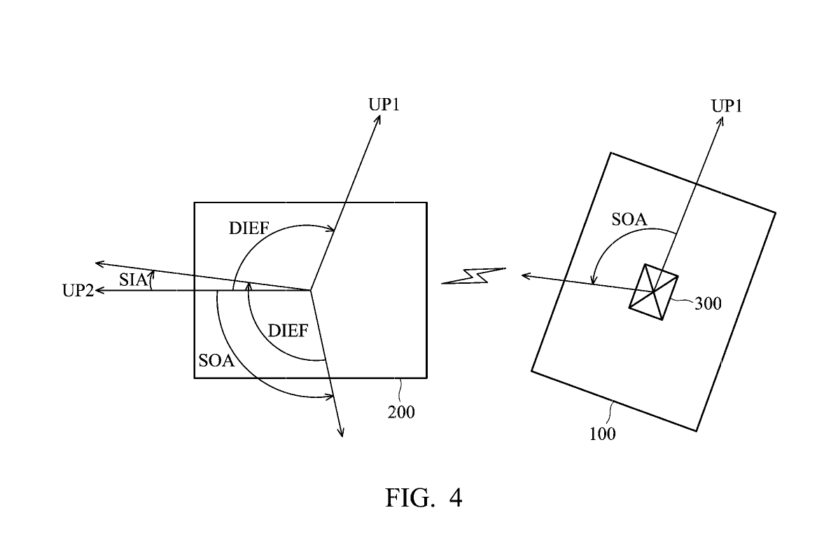

FIG. 4 is a schematic diagram illustrating an embodiment of an angle calculation of the invention. As shown in FIG. 4, the transmitting device 100 transmits the file 300 by a gesture with a sliding-out angle SOA relative to the compass sensor angle UP1 to the electronic device 200, wherein UP2 represents the compass sensor angle of the electronic device 200, DIFF represents a difference between UP1 and UP2 (i.e. DIFF=UP2−UP1) and SUM1 represents a sum of SOA and UP1. In this embodiment, the sliding-in angle SIA can be, for example, calculated by following equation:

$$\begin{matrix}SIA = SOA - DIFF = SOA - ( UP 2 - UP 1 ) \\ = SOA + UP 1 - UP 2 = SUM 1 - UP 2.\end{matrix} \qquad ( 1 )$$

For example, if SOA is set to be 90 degrees, UP1 is set to be 0 degree and UP2 is set to be 30 degrees, the sum SUM1 of the SOA and the UP1 equals to 90 degrees and the sliding-in angle SIA can be determined to be 60 degrees using the equation (1).

After the first angle has been determined, in step S308, then the processing unit 220 determines that the file is to be received from the sliding-in angle and generates a receiving screen indicating that the file is being received from the sliding-in angle on the display of its user interface UI in response to the file sharing request upon receiving the file or after the file has been successfully received.

Please note that in addition to compass sensors, other geographic data may also be used in replace of the compass sensor angles UP1 and UP2. For explanation, file sharing for peer-to-peer (P2P) sharing are illustrated as examples in this embodiment, and those skilled in the art will understand that the invention is not limited thereto.

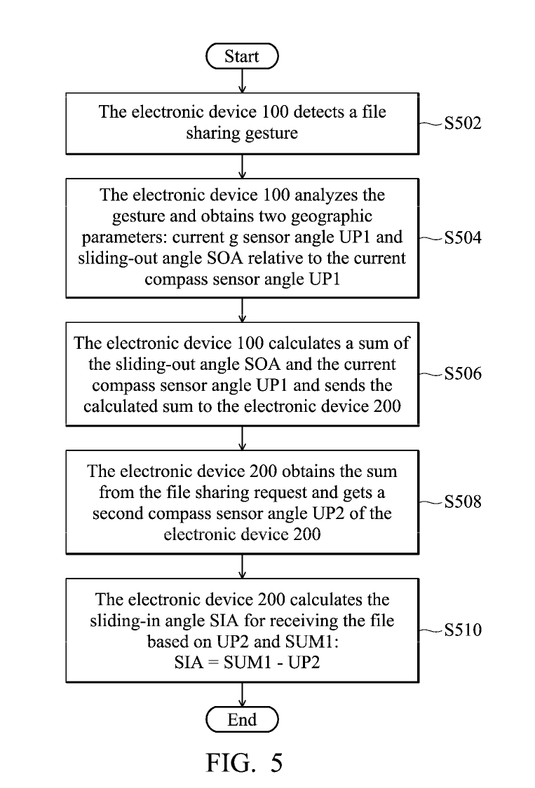

FIG. 5 is a flowchart of another embodiment of a file sharing method of the invention. The file sharing method can be applied to a data transmission system as shown in FIG. 1. Referring together with FIGS. 1, 4 and 5, when a user of the electronic device 100 wishes to request for file sharing with the electronic device 200, the user will touch and generate a sliding-out gesture with a sliding-out angle SOA toward the electronic device 200 on the touch-sensitive display unit 110. And thus the processing unit 120 of the electronic device 100 receives a gesture input from the touch-sensitive display unit 110 and detects/determines that the gesture input represents a file sharing gesture (step S502). The electronic device 100 may then analyze the gesture and obtain two geographic parameters: current compass sensor angle UP1 and the sliding-out angle SOA relative to the current compass sensor angle UP1 (step S504). For example, if the current compass sensor angle UP1 is set as zero degree, the sliding-out angle SOA can be defined as an included angle of the current compass sensor angle UP1 and the sliding-out gesture vector as shown in FIG. 4. The electronic device 100 then calculates a sum SUM1 of the sliding-out angle SOA and the current compass sensor angle UP1 and sends the calculated sum SUM1 to the electronic device 200 (step S506). Upon receiving a file sharing request with the sum, the electronic device 200 obtains the sum from the file sharing request and gets a second compass sensor angle UP2 measured by the sensor 230 (e.g. the compass sensor) of the electronic device 200 (step S508). The electronic device 200 can then calculate the sliding-in angle SIA for receiving the file based on the second compass sensor angle UP2 and the sum SUM1 of the sliding-out angle SOA and the current compass sensor angle UP1 (step S510). For example, the sliding-in angle SIA can be calculated by the equation (1): SIA=SUM1−UP2, as shown in FIG. 4. For example, if SOA is set to be 90 degrees, UP1 is set to be 0 degree and UP2 is set to be 30 degrees, the sum SUM1 of the SOA and the UP1 equals to 90 degrees and the sliding-in angle SIA can be determined to be 60 degrees using the equation (1).

When the sliding-in angle SIA is determined, the processing unit 220 of the electronic device 200 can then display the file from the sliding-in angle SIA, wherein the processing unit 220 can further generate a receiving screen indicating that content of the file appears from the sliding-in angle SIA which is opposite to the sliding-out angle SOA on the user interface of the touch-sensitive display unit 110 for indicating the user the direction that the file is being received from.

In some embodiments, if the display unit 210 is a touch-sensitive display unit, the processing unit 220 may also request for file sharing with a nearby device (e.g. the electronic device 100). Similarly, the processing unit 220 may perform similar steps shown in FIG. 2 to receive a gesture input from the touch-sensitive display unit, determines whether the gesture input matches a file sharing gesture. And when the gesture input matches the file-sharing gesture, the processing unit 220 obtains the second geographic data from the sensor unit of the electronic device 200 and angle information indicating a sliding-out angle relative to the second geographic data associated with a sliding-out gesture, and calculates a sum of the second geographic data and the sliding-out angle included in the angle information. Then the electronic device 200 transmits a file sharing request including the calculated sum to the nearby device and a selected file to request for file sharing.

Upon receiving the file sharing request from the electronic device 200, the nearby device can further determine a second angle for receiving the selected file from the electronic device 200 according to the calculated sum included in the file-sharing request and the first geographic data from the first sensor of the nearby device. For example, the second angle can be obtained by the nearby device by subtracting the first compass data from the sum.

In some embodiments, the electronic device may configure a known sharing group in advance, and then selectively share the data to a portion of or all of members within the sharing group. In a specific embodiment, the electronic device (e.g. the electronic device 100) and the nearby device (e.g. the electronic device 200) are face to face, so the electronic device may directly perform a P2P transmission with the nearby device and the display of the user interface of the electronic device and the nearby device will represent a responsive visual effect.

For example, referring to FIG. 4, the transmitting device 100 transmits the file 300 by a gesture with a sliding-out angle SOA relative to the compass sensor angle UP1 to the electronic device 200. Then, the processing unit 120 of the transmitting device 100 transmits a file sharing request including the compass sensor angle UP1 of the electronic device 100 and the sliding-out angle SOA. Upon receiving the file sharing request, the electronic device 200 can determine the direction that the gesture of the electronic device 100 is directed to (e.g. the sliding-in angle SIA) based on the compass sensor angle UP1 of the electronic device 100, the sliding-out angle SOA included in the file-sharing request, and a compass sensor angle UP2 of the electronic device 200. After aligning by the compass sensor angle UP1 of the electronic device 100 and the compass sensor angle UP2 of the electronic device 200, the angular deviation between the electronic device 100 and the electronic device 200 can be compensated, and the actual direction that the gesture of the electronic device 100 is directed to can be obtained according to the compass sensor angle UP1, the sliding-out angle SOA, and the compass sensor angle UP2. For example, if the direction of the sliding-out gesture of the electronic device 100 is directed to right side of the electronic device 100 (e.g. a sliding-out angle of 90 degrees), the user interface UI of the electronic device 200 may display a visual effect that is changed from left to right (e.g. a sliding-in angle of 270 degrees) according to the compass sensor angle UP1, the compass sensor angle UP2 and the sliding-out angle SOA to indicate that the transmitting device has sent out the file by a gesture that slides from left to right at the sliding-out angle.

In some embodiments, the electronic device 200 (e.g. a handheld device) may transmit the file to or receive files from multiple nearby electronic devices 100 (e.g. other handheld devices) at one time. For example, the electronic device 200 may receive a first file sharing request with a first geographic data, a first angle information and a first file from a first nearby device and a second file sharing request with a second geographic data, a second angle information and a second file from a second nearby device, and then the electronic device 200 can obtain a third geographic data from its sensor and determine a first angle for receiving the first file based on the first and third geographic data and the first angle information and determine a second angle for receiving the second file based on the second and third geographic data and the second angle information. After determining the first and second angles, the electronic device 200 may then generate a receiving screen indicating that the first file is being received from the first angle and the second file is being received from the second angle on the display of its user interface UI in response to the first and second file sharing requests during receiving the first and/or second file.

Therefore, the file sharing methods and related electronic devices of the invention can provide entertaining file sharing methods for users, and a file sharing command to transmit the file to be shared (e.g. pictures, audio files and so on) can be issued by intuitively using directional gestures, such that the display on the user interface of the electronic device located in a responsive direction can display a visual effect corresponding to the gesture. By doing so, the electronic device at the receiving end may determine the direction that the transmitting device sends the file from by calculating a sliding-in angle using the geographic data of the electronic device and the transmitting device and angle information received from the transmitting device to receive the file therefrom even if the electronic device and the transmitting device are located in different directions or angles relatively, thus, increasing fun of the data sharing operation. In addition, the file sharing methods and related electronic devices of the invention can perform a P2P sharing to share data to another peer or simultaneously share the data to or from multiple devices within a predetermined group user.

File sharing methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A file-sharing method, applied to an electronic device at least comprising a display unit and a sensor unit, wherein the electronic device is wirelessly connected to a nearby device, the method comprising:
receiving a file-sharing request from the nearby device, wherein the file-sharing request comprises a first geographic data of the nearby device, angle information indicating a first sliding-out angle relative to the first geographic data, and a file;
obtaining a second geographic data from the sensor unit; and
determining a first angle for receiving the file according to the first geographic data, the angle information and the second geographic data and receiving the file from the first angle.

2. The file-sharing method of claim 1, wherein the step of determining the first angle for receiving the file according to the first geographic data, the angle information and the second geographic data further comprises:
calculating a difference between the first geographic data and the second geographic data; and
determining the first angle by subtracting the calculated difference from the first sliding-out angle included in the angle information.

3. The file-sharing method of claim 1, further comprising:
generating a receiving screen indicating that the file is being received from the first angle on the display of a user interface of the display unit.

4. The file-sharing method of claim 1, wherein the first angle is an angle opposite to the angle information.

5. The file-sharing method of claim 1, wherein the display unit is a touch-sensitive display unit, and the method further comprises:
receiving a gesture input from the touch-sensitive display unit;
determining whether the gesture input matches a file-sharing gesture; and
in response to the gesture input matching the file-sharing gesture, obtaining the second geographic data from the second sensor and angle information indicating a second sliding-out angle relative to the second geographic data associated with the gesture input, calculating a sum of the second geographic data and the sliding-out angle included in the angle information, and transmitting a file-sharing request including the calculated sum and a selected file to the nearby device to request for file sharing.

6. The file-sharing method of claim 5, further comprising:
determining, by the nearby device, a second angle for receiving the selected file from the electronic device according to the calculated sum included in the file-sharing request and the first geographic data from a first sensor unit of the nearby device.

7. The file-sharing method of claim 1, wherein the receiving of the file-sharing request further comprises receiving the file-sharing request via a wireless transmission, and wherein the wireless transmission is selected from one of the following protocols: infra-red (IR), Near Field Communication (NFC), WiFi, and Bluetooth.

8. The file-sharing method of claim 1, wherein the first sensor and the second sensor are selected from at least one of the following sensors: compass sensor, gyro sensor, acceleration sensor, gravity sensor, and GPS sensor.

9. An electronic device, which is wirelessly connected to a nearby device, comprising:
a display unit, arranged for displaying a user interface;
a sensor unit, for providing a second geographic data of the electronic device; and
a processing unit, arranged for receiving a file-sharing request from the nearby device, wherein the file-sharing request comprises a first geographic data of the nearby device, angle information indicating a sliding-out angle relative to the first geographic data and a file, obtaining the second geographic data from the sensor unit, and determining a first angle according to the first geographic data, the sliding-out angle included in the angle information and the second geographic data and receiving the file from the first angle.

10. The electronic device of claim 9, wherein the processing unit further generates a receiving screen indicating that the file is being received from the first angle on the user interface of the display unit.

11. The electronic device of claim 9, wherein the first angle is an angle opposite to the angle information.

12. The electronic device of claim 9, wherein the display unit is a touch-sensitive display unit, and the processing unit further receives a gesture input from the touch-sensitive display unit, determines whether the gesture input matches a file-sharing gesture, and in response to the gesture input matching the file-sharing gesture, obtains the second geographic data from the sensor unit and a second sliding-out angle relative to the second geographic data associated with the gesture input, calculates a sum of the second geographic data and the second sliding-out angle, and transmits a second file-sharing request including the calculated sum to the nearby device to request for file sharing.

13. The electronic device of claim 9, wherein the processing unit is further arranged for detecting a touch on the touch-sensitive display unit and determining whether the detected touch is a predetermined gesture input.

14. The electronic device of claim 9, wherein the sensor unit comprises at least one of the following sensors: compass sensor, gyro sensor, acceleration sensor, gravity sensor, and GPS sensor.

15. The electronic device of claim 9, further comprises a transmission interface unit for receiving the file-sharing request in a wireless transmission protocol, and wherein the wireless transmission protocol is selected from one of the following: infra-red (IR), Near Field Communication (NFC), WiFi, and Bluetooth.

16. A machine-readable storage medium comprising a computer program, which, when executed, causes a device to perform a file-sharing method for an electronic device, wherein the method comprises:
receiving a file-sharing request from the nearby device, wherein the file-sharing request comprises a first compass data from a first compass sensor of the nearby device, angle information indicating a sliding-out angle relative to the first compass data associated with a sliding-out gesture, and a file;
obtaining a second compass data from the compass sensor of the electronic device; and
determining a first angle for receiving the file according to the first compass data, the angle information and the second compass data and receiving the file from the first angle.
